(19) United States
(12) Patent Application Publication
(10) Pub. No.: US 2024/0184525 A1
(43) Pub. Date: Jun. 6, 2024

(54) INFORMATION PROCESSING APPARATUS, INFORMATION PROCESSING METHOD, AND COMPUTER-READABLE NON-TRANSITORY STORAGE MEDIUM

(71) Applicant: NEC Corporation, Tokyo (JP)

(72) Inventors: Dai KUBOTA, Tokyo (JP); Yuta IDEGUCHI, Tokyo (JP); Fumiyo TAKANO, Tokyo (JP); Ryutaro DOI, Tokyo (JP); Hiroaki INOUE, Tokyo (JP); Takahiro NISHIMURA, Tokyo (JP)

(73) Assignee: NEC Corporation, Tokyo (JP)

(21) Appl. No.: 18/384,142

(22) Filed: Oct. 26, 2023

(30) Foreign Application Priority Data
Dec. 1, 2022 (JP) 2022-193133

(51) Int. Cl. G06F 7/535

(52) U.S. Cl. CPC G06F 7/535

(57) ABSTRACT

At least one processor included in an information processing apparatus carries out: a division process of dividing input constraint conditions into a plurality of groups; a conversion process of converting the constraint conditions into a predetermined format; and an integration process of integrating the constraint conditions which are expressed in the predetermined format. In the conversion process, the processor carries out, in a parallel manner, a plurality of processes which respectively correspond to the plurality of groups, where each of the plurality of processes is constituted by conversion processes on respective constraint conditions belonging to one group. This makes it possible to support decision making of a user.

This Nonprovisional application claims priority under 35 U.S.C. § 119 on Patent Application No. 2022-193133 filed in Japan on Dec. 1, 2022, the entire contents of which are hereby incorporated by reference.

### TECHNICAL FIELD

The present invention relates to an information processing apparatus, an information processing method, and a computer-readable non-transitory storage medium which are used in a process of converting, into a predetermined format, a constraint condition imposed on an optimization problem.

### BACKGROUND ART

A technique for high-speed processing is demanded in regard to a mathematical model that represents an optimization problem in which an objective function to be optimized is minimized or maximized under a constraint condition that defines a search range of an optimum solution.

Patent Literature 1 discloses a genetic algorithm parallel processing apparatus that determines whether individuals, which are candidate solutions of an optimization problem, can be exchanged among a plurality of processors. In a case where it has been determined that the individuals can be exchanged, the genetic algorithm parallel processing apparatus exchanges the individuals between the processors.

### CITATION LIST

### Patent Literature

[Patent Literature 1]

Japanese Patent Application Publication, Tokukai, No. 2002-170097

### SUMMARY OF INVENTION

### Technical Problem

In a case where a mathematical model representing an optimization problem is constructed, a plurality of constraint conditions which have been input by a user are used. When constructing a mathematical model that represents an optimization problem, it is necessary to convert these constraint conditions into a format suitable for incorporation into the mathematical model. Therefore, there is a problem that construction of a mathematical model takes time. Under the circumstances, enhancement of speed to construct a mathematical model is also demanded. However, Patent Literature 1 described above does not mention a technique for enhancing a speed to construct a mathematical model.

An example aspect of the present invention is accomplished in view of the above problem, and an example object thereof is to provide a technique for enhancing a speed to construct a mathematical model that represents an optimization problem.

### Solution to Problem

An information processing apparatus in accordance with an example aspect of the present invention includes at least one processor, the at least one processor carrying out: a division process of dividing, into a plurality of groups, a plurality of constraint conditions which have been input; a conversion process of converting each of the plurality of constraint conditions into a predetermined format; and an integration process of integrating the plurality of constraint conditions which are expressed in the predetermined format, in the conversion process, the at least one processor carrying out, in a parallel manner, a plurality of processes which respectively correspond to the plurality of groups, where each of the plurality of processes is constituted by conversion processes on respective constraint conditions belonging to one group.

An information processing method in accordance with an example aspect of the present invention includes: dividing, into a plurality of groups by at least one processor, a plurality of constraint conditions which have been input; carrying out, by the at least one processor, a conversion process of converting each of the plurality of constraint conditions into a predetermined format; and integrating, by the at least one processor, the plurality of constraint conditions which are expressed in the predetermined format, in the carrying out, a plurality of processes which respectively correspond to the plurality of groups being carried out in a parallel manner by the at least one processor, where each of the plurality of processes is constituted by conversion processes on respective constraint conditions belonging to one group.

A computer-readable non-transitory storage medium in accordance with an example aspect of the present invention stores a program for causing a computer to function as an information processing apparatus, the program causing the computer to carry out: a division process of dividing, into a plurality of groups, a plurality of constraint conditions which have been input; a conversion process of converting each of the plurality of constraint conditions into a predetermined format; and an integration process of integrating the plurality of constraint conditions which are expressed in the predetermined format, in the conversion process, a plurality of processes which respectively correspond to the plurality of groups being carried out in a parallel manner by the computer, where each of the plurality of processes is constituted by conversion processes on respective constraint conditions belonging to one group.

### Advantageous Effects of Invention

According to an example aspect of the present invention, it is possible to enhance a speed to construct a mathematical model that represents an optimization problem.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment of the present invention.

FIG. 3 is a block diagram illustrating a configuration of an information processing apparatus in accordance with a second example embodiment of the present invention.

FIG. 4 is a flowchart illustrating a flow of an information processing method in accordance with the second example embodiment of the present invention.

FIG. 5 is a flowchart illustrating an example of processes in step S22 through step S26 in the second example embodiment of the present invention.

FIG. 6 is a diagram illustrating an example of a process in which a division section in accordance with the second example embodiment of the present invention divides a plurality of input constraint conditions into a plurality of groups.

FIG. 7 is a diagram illustrating another example of a process in which a division section in accordance with the second example embodiment of the present invention divides a plurality of input constraint conditions into a plurality of groups.

FIG. 8 is a diagram illustrating an example of a process which is carried out by a conversion section and an integration section in accordance with the second example embodiment of the present invention.

FIG. 9 is a diagram illustrating another example of a process which is carried out by a conversion section and an integration section in accordance with the second example embodiment of the present invention.

FIG. 10 is a block diagram illustrating an example of a hardware configuration of the information processing apparatus according to each of the example embodiments of the present invention.

FIG. 11 illustrates an example of a table in an example application of the present invention.

### EXAMPLE EMBODIMENTS

### First Example Embodiment

The following description will discuss a first example embodiment of the present invention in detail, with reference to the drawings. The present example embodiment is a basic form of example embodiments described later.

### Configuration of Information Processing Apparatus 1

An information processing apparatus 1 in accordance with the present example embodiment converts each of a plurality of constraint conditions into a predetermined format. Then, the information processing apparatus 1 integrates the plurality of constraint conditions which are expressed in the predetermined format. The predetermined format refers to a format suitable for incorporation into a mathematical model that represents an optimization problem.

In the present example embodiment below, a case will be described in which a user inputs a plurality of constraint conditions. Note, however, that a method for inputting constraint conditions is not limited to this. For example, the information processing apparatus 1 may receive input of a plurality of constraint conditions from another system through an application programming interface (API).

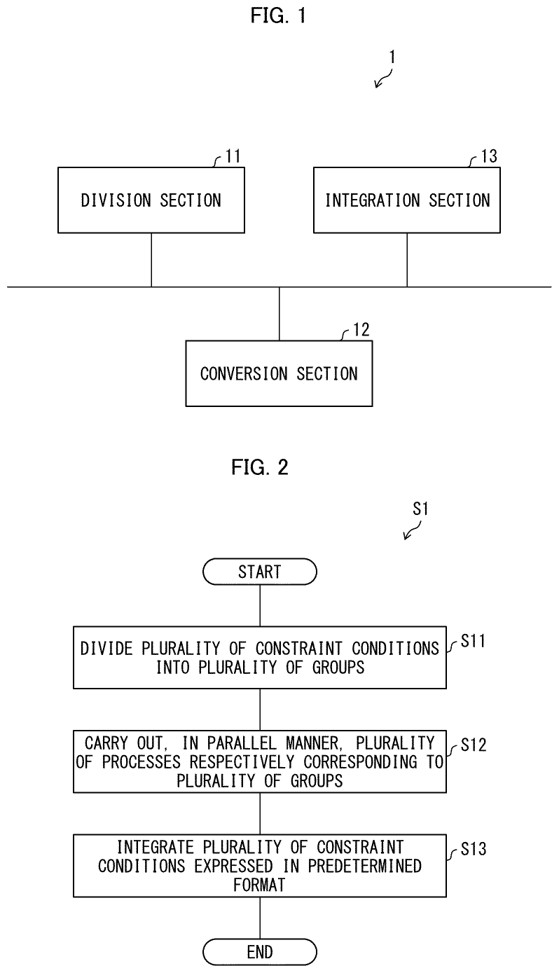

The following description will discuss a configuration of the information processing apparatus 1 in accordance with the present example embodiment, with reference to FIG. 1. FIG. 1 is a block diagram illustrating the configuration of the information processing apparatus 1 in accordance with the present example embodiment.

As illustrated in FIG. 1, the information processing apparatus 1 includes a division section 11, a conversion section 12, and an integration section 13. The division section 11, the conversion section 12, and the integration section 13 are configured to realize the division means, the conversion means, and the integration means in the present example embodiment.

The division section 11 divides, into a plurality of groups, a plurality of constraint conditions which have been input by the user. Each group includes one or more constraint conditions. The division section 11 supplies the plurality of divided groups to the conversion section 12.

The conversion section 12 carries out a conversion process of converting each of the plurality of constraint conditions into a predetermined format. Moreover, the conversion section 12 carries out a plurality of processes, which respectively correspond to the plurality of groups, in a parallel manner, where each of the plurality of processes is constituted by conversion processes on respective constraint conditions belonging to one group. The conversion section 12 supplies the plurality of constraint conditions which are expressed in the predetermined format to the integration section 13.

The integration section 13 integrates the plurality of constraint conditions which are expressed in the predetermined format.

As described above, the information processing apparatus 1 in accordance with the present example embodiment employs the configuration of including: the division section 11 that divides, into a plurality of groups, a plurality of constraint conditions which have been input by a user; the conversion section 12 that carries out a conversion process of converting each of the plurality of constraint conditions into a predetermined format; and the integration section 13 that integrates the plurality of constraint conditions which are expressed in the predetermined format. Moreover, the conversion section 12 in the information processing apparatus 1 in accordance with the present example embodiment carries out a plurality of processes, which respectively correspond to the plurality of groups, in a parallel manner, where each of the plurality of processes is constituted by conversion processes on respective constraint conditions belonging to one group.

As such, according to the information processing apparatus 1 in accordance with the present example embodiment, a plurality of constraint conditions which have been input by a user is divided into a plurality of groups, and a plurality of processes which respectively correspond to the plurality of groups are carried out in a parallel manner, where each of the plurality of processes is constituted by conversion processes for conversion into a predetermined format which are carried out on respective constraint conditions belonging to one group. Therefore, it is possible to enhance a speed of a conversion process, as compared with a case in which conversion processes of converting a plurality of constraint conditions into a predetermined format are carried out in a serial manner. The plurality of constraint conditions which are expressed in the predetermined format are integrated, and the plurality of constraint conditions thus integrated can be used for construction of a mathematical model. Therefore, according to the information processing apparatus 1 in accordance with the present example embodiment, it is possible to bring about an example advantage of enhancing a speed to construct a mathematical model which represents an optimization problem.

### Flow of Information Processing Method S1

The following description will discuss a flow of an information processing method S1 in accordance with the present example embodiment, with reference to FIG. 2. FIG. 2 is a flowchart illustrating the flow of the information processing method S1 in accordance with the present example embodiment.

### Step S11

In step S11, the division section 11 divides, into a plurality of groups, a plurality of constraint conditions which have been input by the user. The division section 11 supplies the plurality of divided groups to the conversion section 12.

### Step S12

In step S12, the conversion section 12 carries out a conversion process of converting each of the plurality of constraint conditions into a predetermined format. Moreover, in step S12, the conversion section 12 carries out a plurality of processes, which respectively correspond to the plurality of groups, in a parallel manner, where each of the plurality of processes is constituted by conversion processes on respective constraint conditions belonging to one group. The conversion section 12 supplies the plurality of constraint conditions which are expressed in the predetermined format to the integration section 13.

### Step S13

In step S13, the integration section 13 integrates the plurality of constraint conditions which are expressed in the predetermined format.

As described above, the information processing method S1 in accordance with the present example embodiment employs the configuration of including: step S11 in which the division section 11 divides, into a plurality of groups, a plurality of constraint conditions which have been input by a user; step S12 in which the conversion section 12 carries out a conversion process of converting each of the plurality of constraint conditions into a predetermined format; and step S13 in which the integration section 13 integrates the plurality of constraint conditions which are expressed in the predetermined format. Moreover, in step S12, the conversion section 12 carries out a plurality of processes, which respectively correspond to the plurality of groups, in a parallel manner, where each of the plurality of processes is constituted by conversion processes on respective constraint conditions belonging to one group. Therefore, according to the information processing method S1 in accordance with the present example embodiment, an example advantage similar to that of the foregoing information processing apparatus 1 is brought about.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

### Overview of Information Processing Apparatus 2

An information processing apparatus 2 in accordance with the present example embodiment converts, into a predetermined format, each of a plurality of constraint conditions which have been input. Then, the information processing apparatus 2 integrates the plurality of constraint conditions which are expressed in the predetermined format.

In the present example embodiment below also, a case will be described in which a user inputs a plurality of constraint conditions. Note, however, that a method for inputting constraint conditions is not limited to this. For example, the information processing apparatus 2 may receive input of a plurality of constraint conditions from another system through an API.

Examples an optimization problem related to a plurality of constraint conditions in the present example embodiment include a linear programming problem, an integer linear programming problem, a mixed integer linear programming problem, and a quadratic unconstrained binary optimization (QUBO) problem.

The linear programming problem is a problem for identifying consecutive integers x₁, x₂, . . . , xₙ that maximize a given function f(x₁, x₂, . . . , xₙ).

The integer linear programming problem is a problem for identifying integer variables (discrete variables) x₁, x₂, . . . , xₙ that maximize a given function f(x₁, x₂, . . . , xₙ).

The mixed integer linear programming problem is a problem for identifying variables x₁, x₂, . . . , xₙ in which a continuous variable and an integer variable are mixedly present and which maximize a given function f(x₁, x₂, . . . , xₙ).

The QUBO problem is a problem for identifying variables x₁, x₂, . . . , xₙ that minimize J in the following formula (1).

$$J = {\sum }_{i \neq j} {Q}_{ij} {x}_{i} {x}_{j} \qquad ( 1 )$$

Examples of a format suitable for incorporation into a mathematical model that represents a constrained linear programming problem, a constrained integer linear programming problem, and a constrained mixed integer linear programming problem include a linear programming (LP) format and a mathematical programming system (MPS) format.

Example of a format suitable for incorporation into a mathematical model that represents a QUBO problem is a format in which each constraint condition is expressed by a coefficient included in a penalty term representing that constraint condition.

### Configuration of Information Processing Apparatus 2

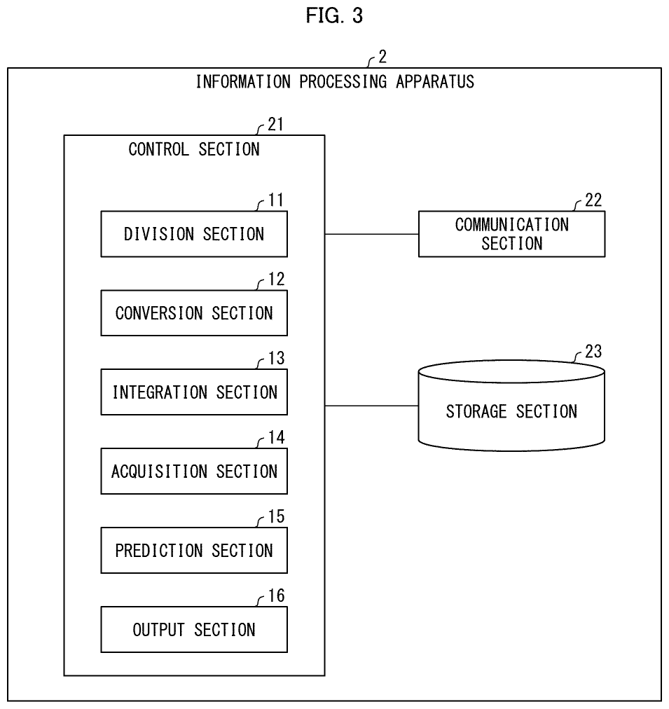

The following description will discuss a configuration of the information processing apparatus 2 in accordance with the present example embodiment, with reference to FIG. 3. FIG. 3 is a block diagram illustrating a configuration of the information processing apparatus 2 in accordance with the present example embodiment. As illustrated in FIG. 3, the information processing apparatus 2 includes a control section 21, a communication section 22, and a storage section 23.

The communication section 22 is an interface that transmits and receives data. Examples of data received by the communication section 22 include a constraint condition which is expressed in a first format and an optimization program which is described while including that constraint condition. Examples of data transmitted by the communication section 22 include integrated constraint conditions which have been subjected to conversion processes. Examples of an apparatus to which the communication section 22 transmits data include an optimization problem solver. The information processing apparatus 2 transmits, via the communication section 22, a plurality of constraint conditions which are expressed in a predetermined format to the optimization problem solver.

The information processing apparatus 2 may be configured to include, instead of or in addition to the communication section 22, a data input section which is an interface for receiving data input, and a data output section which is an interface for outputting data.

The storage section 23 stores data which the control section 21 refers to. Examples of data stored in the storage section 23 include: a plurality of constraint conditions which have been input by a user; groups each including one or more constraint conditions; a plurality of constraint conditions which are expressed in a predetermined format; predicted process times associated with the constraint conditions (details of the predicted process time will be described later); and integrated constraint conditions.

### Function of Control Section 21

The control section 21 controls constituent elements included in the information processing apparatus 2.

As illustrated in FIG. 3, the control section 21 includes a division section 11, a conversion section 12, an integration section 13, an acquisition section 14, a prediction section 15, and an output section 16. The division section 11, the conversion section 12, the integration section 13, and the prediction section 15 are configured to realize the division means, the conversion means, the integration means, and the prediction means, respectively, in the present example embodiment.

The control section 21 may include an optimization problem solver, which is not illustrated in FIG. 3. In this case, in the control section 21, a plurality of constraint conditions which are expressed in a predetermined format are supplied to the optimization problem solver included in the control section 21.

The division section 11 divides, into a plurality of groups, a plurality of constraint conditions which have been input by a user. For example, the division section 11 acquires a plurality of constraint conditions which have been input by a user and are stored in the storage section 23, and divides the plurality of acquired constraint conditions into a plurality of groups. Each of the plurality of groups includes one or more constraint conditions. The division section 11 causes the storage section 23 to store the plurality of groups which have been obtained by the division. An example of a process in which the division section 11 divides a plurality of constraint conditions into a plurality of groups will be described later.

The conversion section 12 carries out a conversion process of converting each of the plurality of constraint conditions into a predetermined format. Moreover, the conversion section 12 carries out a plurality of processes, which respectively correspond to the plurality of groups, in a parallel manner, where each of the plurality of processes is constituted by conversion processes on respective constraint conditions belonging to one group. The conversion section 12 causes the storage section 23 to store the plurality of constraint conditions which have been subjected to the conversion processes and are expressed in the predetermined format.

The integration section 13 integrates the plurality of constraint conditions which are expressed in the predetermined format. For example, the integration section 13 integrates the plurality of constraint conditions which are stored in the storage section 23 and are expressed in the predetermined format. The integration section 13 causes the storage section 23 to store the integrated constraint conditions. An example of a process in which the integration section 13 integrates the plurality of constraint conditions which are expressed in the predetermined format will be described later.

The acquisition section 14 acquires a plurality of constraint conditions which have been input by a user. An example of a configuration in which the acquisition section 14 acquires a plurality of constraint conditions is a configuration in which a plurality of constraint conditions which have been input by a user is acquired via the communication section 22. Another example of the configuration in which the acquisition section 14 acquires a plurality of constraint conditions is a configuration in which a program for optimization described while including the plurality of constraint conditions is acquired via the communication section 22, and by extracting the plurality of constraint conditions from the program, the plurality of constraint conditions which have been input by the user are acquired. The acquisition section 14 causes the storage section 23 to store the plurality of constraint conditions which have been acquired.

The prediction section 15 predicts a process time that is taken for the conversion section 12 to carry out a conversion process on each of the plurality of constraint conditions. The prediction section 15 causes the storage section 23 to store the predicted process times in association with the respective constraint conditions.

An example of a method in which the prediction section 15 predicts a process time is a method in which, with use of a prediction model generated by machine learning while using a plurality of constraint conditions as input, a process time that is taken for the conversion section 12 to carry out a conversion process on each constraint condition is predicted.

The prediction model is information that represents a relationship between an explanatory variable and an objective variable. The prediction model is, for example, a component for estimating a result of an estimation target by calculating an objective variable based on an explanatory variable. The prediction model may be referred to as a “learning model”, an “analysis model”, an “AI model”, a “learned model”, an “inference model”, or a “prediction expression”.

A training algorithm for generating the prediction model is not particularly limited and may be an existing training algorithm. For example, the training algorithm can be a random forest, a support vector machine, Naive Bayes, or a neural network.

As another example of the method in which the prediction section 15 predicts a process time, a method can be employed in which a rule-based algorithm is used to predict a process time that is taken for the conversion section 12 to carry out a conversion process on each of the plurality of constraint conditions. The following description will discuss an example of this configuration.

For example, a constraint condition (character string) in an LP format is described by the number of terms each having a non-zero (not 0) coefficient in a constraint condition formula. For example, in a case where a constraint condition is “x1+x2=1” in a situation where there are variables x1 through x10, only coefficients of the variables x1 and x2 have 1, which is a non-zero value, and coefficients of the other variables x3 through x10 are 0 (which are not non-zero coefficients). Therefore, it can be said that a process time of a conversion process on an input constraint condition is proportional to the number of non-zero coefficients in the constraint condition.

In view of this, first, the prediction section 15 measures, in advance, a process time T of a conversion process of converting a constraint condition having one coefficient into a predetermined format. Then, the prediction section 15 inputs the measured process time T and the constraint condition into a rule-based algorithm. In the rule-based algorithm, the number of non-zero coefficients in the constraint condition is measured, and “(the number of non-zero coefficients in the constraint condition)×T” is calculated. The prediction section 15 sets a value of “(the number of non-zero coefficients in the constraint condition)×T” calculated by the rule-based algorithm to a predicted process time.

The output section 16 outputs information. For example, the output section 16 outputs integrated constraint conditions which are stored in the storage section 23 to another apparatus via the communication section 22.

### Flow of Information Processing Method S2

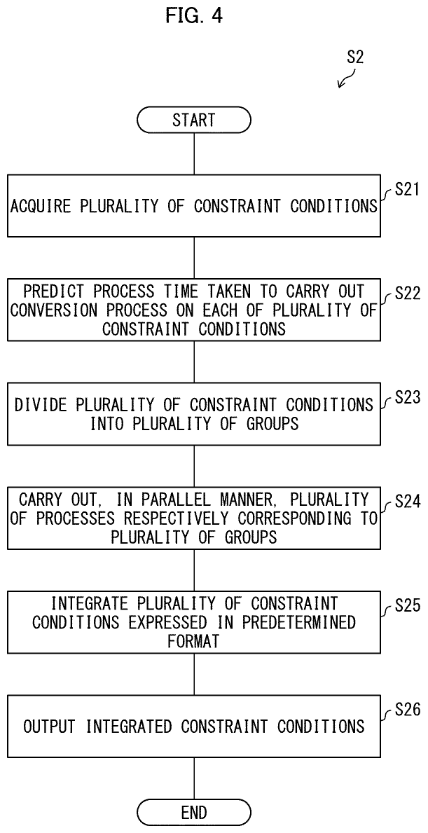

The following description will discuss a flow of an information processing method S2 in accordance with the present example embodiment with reference to FIG. 4. FIG. 4 is a flowchart illustrating the flow of the information processing method S2 in accordance with the present example embodiment.

### Step S21

In step S21, the acquisition section 14 acquires a plurality of constraint conditions which have been input by a user. The acquisition section 14 causes the storage section 23 to store the plurality of constraint conditions which have been acquired.

### Step S22

In step S22, the prediction section 15 predicts a process time that is taken to carry out a conversion process on each of the plurality of constraint conditions stored in the storage section 23. The prediction section 15 causes the storage section 23 to store the predicted process times in association with the respective constraint conditions.

### Step S23

In step S23, the division section 11 acquires the plurality of constraint conditions which have been input by the user and are stored in the storage section 23. Then, the division section 11 divides, into a plurality of groups, the plurality of constraint conditions which have been acquired. The division section 11 causes the storage section 23 to store the plurality of groups which have been obtained by the division.

### Step S24

In step S24, the conversion section 12 carries out a plurality of processes, which respectively correspond to the plurality of groups stored in the storage section 23, in a parallel manner. The conversion section 12 causes the storage section 23 to store the plurality of constraint conditions which are expressed in the predetermined format.

### Step S25

In step S25, the integration section 13 integrates the plurality of constraint conditions which are stored in the storage section 23 and are expressed in the predetermined format. The integration section 13 causes the storage section 23 to store the integrated constraint conditions.

### Step S26

In step S26, the integrated constraint conditions stored in the storage section 23 are output to another apparatus via the communication section 22.

### Example of Processes in Step S22 Through Step S26

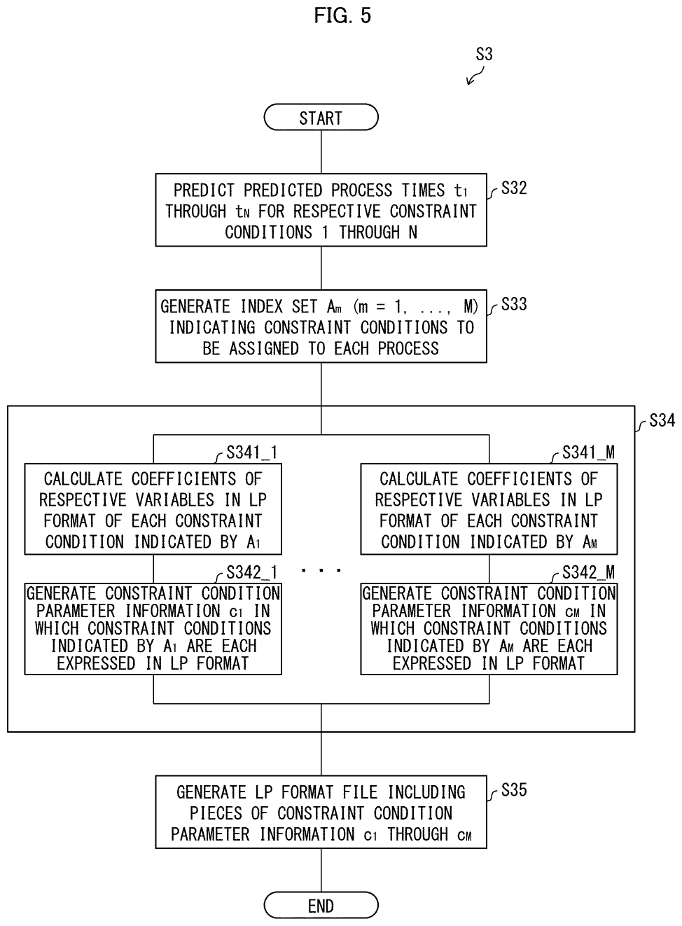

The following description will discuss an example of processes in step S22 through step S26, with reference to FIG. 5. FIG. 5 is a flowchart illustrating an example (information processing method S3) of the processes in step S22 through step S26 in the present example embodiment. In FIG. 5, a case in which the predetermined format is an LP format will be described as an example.

### Step S32

In step S32 (corresponding to step S22), the prediction section 15 predicts predicted process times t₁ through t_{N} that are taken to carry out respective conversion processes on a plurality of constraint conditions 1 through N that are stored in the storage section 23. The prediction section 15 causes the storage section 23 to store the predicted process times t₁ through t_{N} in association with the respective constraint conditions 1 through N.

### Step S33

In step S33 (corresponding to step S23), the division section 11 acquires the plurality of constraint conditions 1 through N that are stored in the storage section 23. Then, the division section 11 generates an index set Aₘ (m=1, . . . , M) indicating constraint conditions to be assigned to each process. For example, in a case where a group GP1 including a constraint condition 1 and a constraint condition 2 is assigned to a process 1, the division section 11 generates an index A₁ indicating that the group GP1 includes the constraint condition 1 and the constraint condition 2. The division section 11 causes the storage section 23 to store the generated index set Am.

### Step S34

In step S34 (corresponding to step S24), the conversion section 12 carries out, in a parallel manner, processes 1 (step S341_1 and step S342_1) through M (step S341_M and step S342_M) corresponding to the respective plurality of groups stored in the storage section 23.

### Step S341_1

For example, in step S341_1, the conversion section 12 acquires the index A₁ from the index sets Am which are stored in the storage section 23. The index A₁ indicates that the group GP1 including the constraint condition 1 and the constraint condition 2 is assigned to the process 1. Therefore, the conversion section 12 calculates coefficients of respective variables in the LP format of the constraint condition 1 and the constraint condition 2. A configuration in which the conversion section 12 calculates coefficients of respective variables in the LP format of a constraint condition will be described later.

### Step S342_1

In step S342_1, the conversion section 12 generates constraint condition parameter information c₁ in which the constraint condition 1 and the constraint condition 2 indicated by the index A₁ are each expressed in the LP format.

Similarly, the conversion section 12 carries out the processes 2 through M in a parallel manner and generates pieces of constraint condition parameter information c₂ through c_{M}. Then, the conversion section 12 causes the storage section 23 to store the generated pieces of constraint condition parameter information c₁ through c_{M}.

### Step S35

In step S35 (corresponding to step S25), the integration section 13 acquires the pieces of constraint condition parameter information c₁ through c_{M} which are stored in the storage section 23 and are expressed in the LP format. Then, the integration section 13 generates an LP format file including the pieces of constraint condition parameter information c₁ through c_{M}.

### Process Example 1 by Division Section 11

A process time in a case where the division section 11 divides N constraint conditions into M groups (in other words, N constraint conditions are converted in M processes) is theoretically expressed by the following formula (2).

$${\sum }_{n = 1}^{N} {T}_{n} \to {max}_{m} \{ {\sum }_{{n}_{1} = 1}^{{N}_{1}} {T}_{{n}_{1}}^{1} , … , {\sum }_{{n}_{m} = 1}^{{N}_{m}} {T}_{{n}_{m}}^{m} , … , {\sum }_{{n}_{M} = 1}^{{N}_{M}} {T}_{{n}_{M}}^{M} \} + {T}_{com} \qquad ( 2 )$$

Tₙ: Process time for n-th constraint condition
Nₘ: Number of constraint conditions assigned to m-th parallel process
Tₙ_{ₘ}^{m}: Process time for each constraint condition assigned to m-th parallel process
   (that is,

$${\{ {T}_{n} \}}_{n = 1 , … , N} and {\{ {T}_{{n}_{m}}^{m} \}}_{m = 1 , … , M , {n}_{m} = 1 , … , {N}_{m}}$$

are the same as a set)
T_{com}: Time taken for communication to aggregate constraint conditions after conversion processes

The division section 11 divides a plurality of constraint conditions into a plurality of groups so that a value of formula (2) is minimized.

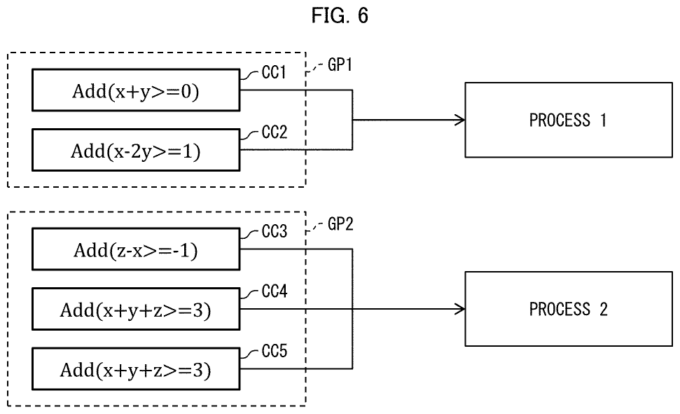

For example, the division section 11 divides the plurality of constraint conditions into the plurality of groups so that a difference in the number of conversion processes is minimized between the plurality of processes carried out in a parallel manner. The following description will discuss an example of this configuration, with reference to FIG. 6. FIG. 6 is a diagram illustrating an example of a process in which the division section 11 in accordance with the present example embodiment divides, into a plurality of groups, a plurality of constraint conditions (constraint conditions CC1 through CC5) which have been input by a user.

In a case where a problem class of the optimization problem is a linear programming problem, an integer linear programming problem, a or mixed integer linear programming problem, a declaration statement of one constraint condition is described by a function Add( ) in a model construction application programming interface (API) (see FIG. 6). Therefore, the division section 11 first counts the number (in other words, the number of constraint conditions which have been input by the user) of functions Add( ) in each of which a constraint condition has been declared.

Next, the division section 11 divides the plurality of constraint conditions into the plurality of groups so that a difference in the number of conversion processes in each of the plurality of processes carried out by the conversion section 12 in a parallel manner is minimized. In FIG. 6, the number of processes is two (the process 1 and the process 2). Therefore, the division section 11 divides the plurality of constraint conditions into (i) a group GP1 including a constraint condition CC1 and a constraint condition CC2 and (ii) a group GP2 including a constraint condition CC3, a constraint condition CC4, and a constraint condition CC5 so that a difference in the number of conversion processes in each of the two processes is minimized. As illustrated in FIG. 6, in a case where the number of constraint conditions is not divisible by the number of processes, the division section 11 divides the constraint conditions into groups so that, in some processes, the number of constraint conditions is one larger than that in the other processes.

As such, the division section 11 divides the plurality of constraint conditions into the plurality of groups so that a difference in the number of conversion processes is minimized between the plurality of processes carried out in a parallel manner. Thus, the division section 11 divides a plurality of constraint conditions into a plurality of groups so that a process time that is taken for the conversion section 12 to carry out conversion processes on all the plurality of constraint conditions is minimized. Therefore, it is possible to enhance a speed to construct a mathematical model that represents an optimization problem.

### Process Example 2 by Division Section 11

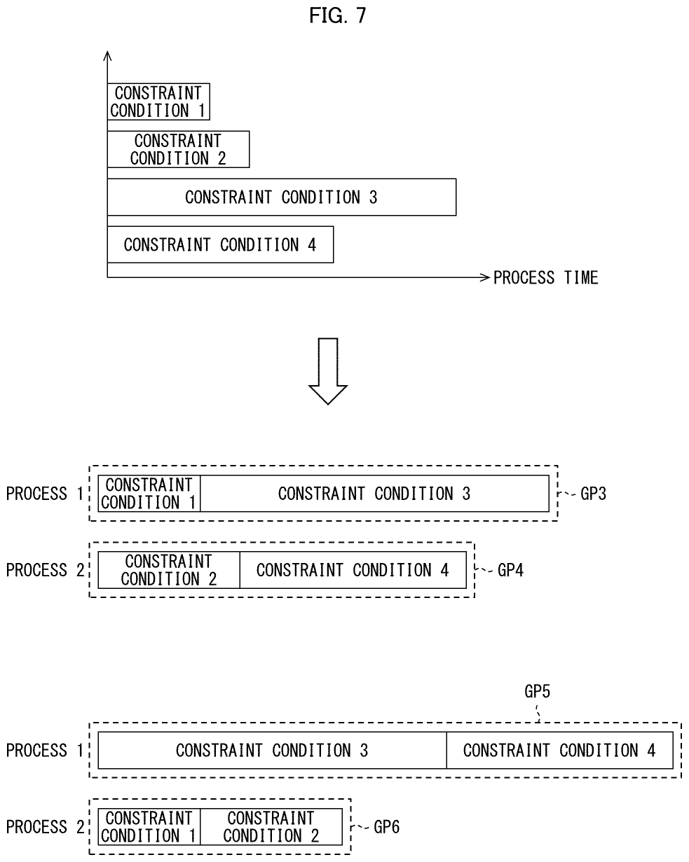

As another example, the division section 11 divides, with reference to process times predicted by the prediction section 15, a plurality of constraint conditions into a plurality of groups so that a value of the foregoing formula (2) is minimized (in other words, so that a process time that is taken for the conversion section 12 to carry out conversion processes on all the plurality of constraint conditions is minimized). The following description will discuss an example of this configuration, with reference to FIG. 7. FIG. 7 is a diagram illustrating another example of the process in which the division section 11 in accordance with the present example embodiment divides, into a plurality of groups, a plurality of constraint conditions which have been input by a user. In FIG. 7, a case is described in which the division section 11 divides four constraint conditions (constraint conditions 1 through 4) into two groups.

First, the division section 11 acquires a predicted process time, which has been predicted by the prediction section 15, of a conversion process on each of the constraint conditions 1 through 4. The following description will discuss a case in which the predicted process times of the respective constraint conditions 1 through 4 which the division section 11 has acquired are predicted process times illustrated in the upper part of FIG. 7. In this case, the division section 11 divides the constraint conditions into (i) a group GP3 including the constraint condition 1 and the constraint condition 3 and (ii) a group GP4 including the constraint condition 2 and the constraint condition 4 (see the middle part of FIG. 7) so that the value of formula (2) is minimized. Then, the group GP3 is assigned to the process 1, and the group GP4 is assigned to the process 2, and the processes 1 and 2 are carried out in a parallel manner by the conversion section 12.

A case will be also described in which the division section 11 divides constraint conditions into (i) a group GP5 including the constraint condition 3 and the constraint condition 4 and (ii) a group GP6 including the constraint condition 1 and the constraint condition 2 (see the lower part of FIG. 7). In this case, before a conversion process with respect to the constraint condition 3 in the process 1 in which the group GP5 is processed ends, conversion processes in the process 2 in which the group GP6 is processed end. Accordingly, conversion processes by the conversion section 12 do not end until the conversion processes in the process 1 end. Therefore, a time for the conversion processes by the conversion section 12 is longer than that indicated in the middle part of FIG. 7.

An example of a method in which the division section 11 divides a plurality of constraint conditions into a plurality of groups with reference to a predicted process time is a method in which the division section 11 divides the plurality of constraint conditions into the plurality of groups by inputting the plurality of constraint conditions and the predicted process time into an estimation algorithm, which has been generated by machine learning, so that a process time that is taken for the conversion section 12 to carry out conversion processes on all the plurality of constraint conditions is minimized.

Another example of a method in which the division section 11 divides a plurality of constraint conditions into a plurality of groups with reference to a predicted process time is a method in which the division section 11 divides the plurality of constraint conditions into the plurality of groups by inputting the plurality of constraint conditions and the predicted process time into a rule-based algorithm so that a process time that is taken for the conversion section 12 to carry out conversion processes on all the plurality of constraint conditions is minimized.

Yet another example of a method in which the division section 11 divides a plurality of constraint conditions into a plurality of groups with reference to a predicted process time is a method in which an optimization problem is created such that a process time that is taken for the conversion section 12 to carry out conversion processes on all the plurality of constraint conditions is minimized, and the optimization problem is solved.

As such, the prediction section 15 predicts a process time that is taken for the conversion section 12 to carry out a conversion process on each of the plurality of constraint conditions. Then, the division section 11 divides, with reference to the process times predicted by the prediction section 15, a plurality of constraint conditions into a plurality of groups so that a process time that is taken for the conversion section 12 to carry out conversion processes on all the plurality of constraint conditions is minimized.

Thus, even in a case where times taken to carry out conversion processes vary greatly for each constraint condition, the division section 11 divides a plurality of constraint conditions into a plurality of groups so that a process time that is taken to carry out the conversion processes on all the plurality of constraint conditions is minimized, and it is therefore possible to enhance a speed to construct a mathematical model that represents an optimization problem.

### Process Example 1 by Conversion Section 12 and Integration Section 13

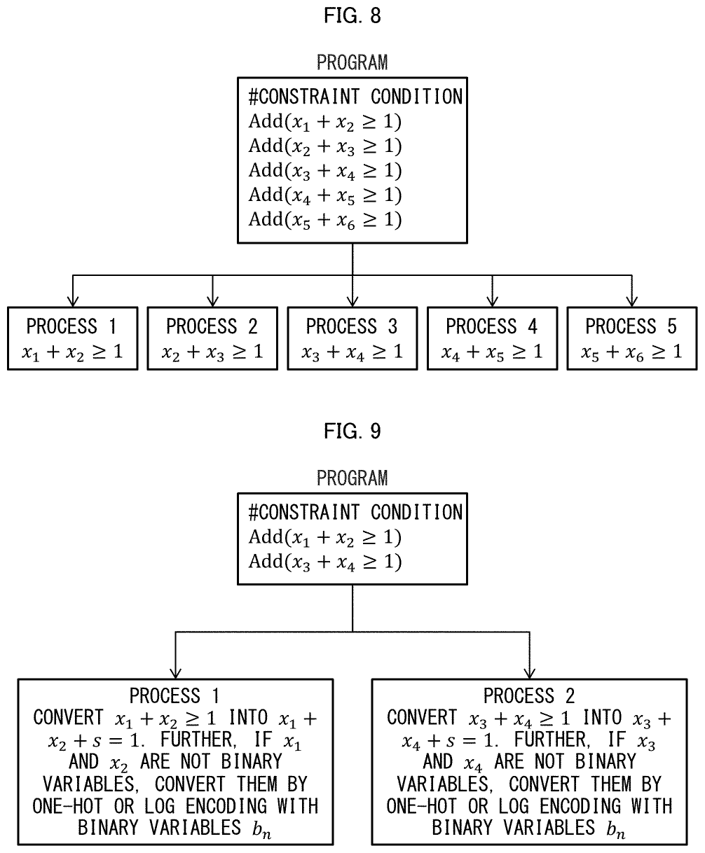

An example of a process which is carried out by the conversion section 12 and the integration section 13 will be described with reference to FIG. 8. FIG. 8 is a diagram illustrating an example of a process which is carried out by the conversion section 12 and the integration section 13 in accordance with the present example embodiment. The example illustrated in FIG. 8 is an example of a process which is carried out by the conversion section 12 and the integration section 13 on a constraint condition that is imposed on a linear programming problem, an integer linear programming problem, or a mixed integer linear programming problem. In the example illustrated in FIG. 8, five constraint conditions are divided into five groups by the division section 11. Then, conversion processes in which the five groups are converted, in respective processes 1 through 5, into an LP format or an MPS format are carried out in a parallel manner by the conversion section 12.

In a case where a constraint condition input by a user is a constraint condition with respect to a linear programming problem, an integer linear programming problem, or a mixed integer linear programming problem, the predetermined format is an LP format or an MPS format. In this case, the conversion section 12 calculates coefficients of respective variables in the LP format of a constraint condition in each of the processes, and generates constraint condition parameter information indicating a constraint condition that is a character string which has been generated based on the calculated coefficients. Specifically, first, the conversion section 12 shifts a term including a variable to the left side, and sets the right side to be a constant. Next, the conversion section 12 transforms the left side and the right side so that the right side is 1. Note that, in a case where the right side is 0, the conversion section 12 does not carry out the transformation process for setting the right side to be 1.

For example, as illustrated in FIG. 8, the conversion section 12 calculates, in the process 1, a coefficient 1 of variables x₁ and x₂ in the LP format from an input constraint condition “Add(x₁+x≥1)”. Then, the conversion section 12 generates constraint condition parameter information by conversion into a character string “x₁+x₂≥1”. Similarly, in the processes 2 through 5, the conversion section 12 generates constraint condition parameter information, as illustrated in FIG. 8. The conversion section 12 supplies the pieces of constraint condition parameter information generated in the respective processes to the integration section 13.

As another example, in a case where an input constraint condition is “Add(x₁≥2−2x₂)”, the conversion section 12 calculates a coefficient 0.5 of a variable x₁ and a coefficient 1 of x₂ in the LP format. Then, the conversion section 12 generates constraint condition parameter information by conversion into a character string “0.5x₁+x₂≥1”.

As yet another example, in a case where the input constraint condition is “Add(0≤x₁≤5)”, the conversion section 12 calculates a coefficient 1 and a coefficient 0.2 of the variable x₁ in the LP format. Then, the conversion section 12 generates constraint condition parameter information by conversion into a character string “x₁≥0” and a character string “0.2x₁≤1”.

The integration section 13 refers to constraint condition parameter information which is expressed in the LP format and generates a file in which character strings of respective constraint conditions are included in respective rows. Moreover, the integration section 13 generates a character string of an item necessary for the format and generates a constraint condition in the LP format suitable for incorporation into a mathematical model. For example, in a case of generating information in the LP format, the integration section 13 generates character strings such as “Maximize”, “Bounds”, and “General” as necessary items.

### Process Example 2 by Conversion Section 12 and Integration Section 13

Another example of a process which is carried out by the conversion section 12 and the integration section 13 will be described with reference to FIG. 9. FIG. 9 is a diagram illustrating another example of a process which is carried out by the conversion section 12 and the integration section 13 in accordance with the present example embodiment. The example illustrated in FIG. 9 is an example of a process which is carried out by the conversion section 12 and the integration section 13 on constraint conditions that are imposed on a QUBO problem.

The following description will discuss a case in which a constraint condition which has been input by a user is a constraint condition for a quadratic unconstrained binary optimization (QUBO) problem. In a case of the QUBO problem, only binary variables can be dealt with in the QUBO problem. Therefore, it is necessary to deal with integer variables only as binary variables. For example, one-hot encoding expression using the following formula (3) can be employed with use of a binary variable bn.

$$x = {\sum }_{n = 1}^{X} {nb}_{n} \qquad ( 3 )$$

Another example is log encoding expression using the following formulae (4) and (5).

$$Y = [ {log}_{2} ( X - 1 ) ] \qquad ( 4 )$$

$$x = {\sum }_{n = 0}^{Y} {2}^{n} {b}_{n} \qquad ( 5 )$$

In a case where a constraint condition is, for example, a linear equality such as “x₁+x₂=1”, the constraint condition is “J=J+K(x₁+x₂−1)²” with respect to an objective function J in the QUBO problem. That is, in a case where the constraint condition “x₁+x₂=1” is change into a format in which the right side of the equality is 0, the constraint condition becomes “x₁+x₂−1=0”. Further, a term (penalty term) obtained by multiplying, by an appropriate constant K, the square of the left side “x₁+x₂−1” in the changed equality is added to the objective function J, and it is thus possible to deal with the constraint condition. Note, however, that, in a case where x₁ or the like is an integer variable, the integer variable is replaced with an expression by a binary variable by the method described above. A size of the constant K can be determined in advance by a user.

Meanwhile, in a case where the constraint condition is, for example, a linear inequality such as “x₁+x₂≥1”, it is possible to convert the constraint condition “x₁+x₂≥1” into “x₁+x₂+s=1” by introducing a positive integer variable s called a slack variable. After conversion, it is possible to deal with the inequality constraint condition by a procedure similar to that in the above described case where the constraint condition is an equality.

That is, in a case where the plurality of constraint conditions which have been input by a user are constraint conditions with respect to a quadratic unconstrained binary optimization problem, the predetermined format is a format in which each of the constraint conditions is expressed by a coefficient included in a penalty term representing that constraint condition.

Next, a method of adding a constraint condition in the QUBO problem will be described. In a case where a problem class of the optimization problem is a QUBO problem, the objective function J is expressed by the following formula (1) described above.

$$J = {\sum }_{i \neq j} {Q}_{ij} {x}_{i} {x}_{j} \qquad ( 1 )$$

In the QUBO problem, model data is described in low-level or data is stored, by coefficients (matrix Q (quadratic array data)) in the objective function J expressed by formula (1) rather than by an LP format.

In a case where a constraint condition is added to a QUBO problem, a form of a function call (e.g., Add(x₁+x₂≥1)) can be used. In this case, assuming that an n-th constraint condition is Add(x₁+x₂≥1), the above-described penalty term “K(x₁+x₂−1)²” is developed in order to add the n-th constraint condition to the QUBO problem. When the penalty term is developed, Qₙ to be added to the matrix Q which is a coefficient is calculated. Then, the calculated Qₙ is added to the matrix Q as in Q=Q+Qₙ.

That is, in a case where a constraint condition is added to the QUBO problem, each Qₙ individually calculated may be added to the matrix Q. Thus, addition of a constraint condition to a QUBO problem model is simply an addition. Therefore, a calculation result does not change according to the order in which constraint conditions are added. Therefore, even in a case where a constraint condition is added to a QUBO problem model, it is possible to carry out calculation as a parallel process.

For example, as illustrated in FIG. 9, in a case where the division section 11 divides two constraint conditions into two groups, the conversion section 12 carries out, in processes 1 and 2 in a parallel manner, conversion processes of conversion into a format.

In this case, as illustrated in FIG. 9, the conversion section 12 first converts, in the process 1, the constraint condition “x₁+x₂≥1” into “x₁+x₂+s=1” and generates a penalty term. Moreover, in a case where variables x₁ and x₂ are not binary variables, the conversion section 12 converts the variables x₁ and x₂ into binary variables by one-hot encoding or log encoding with a binary variable bn. As such, the conversion section 12 expresses a constraint condition by a coefficient included in a penalty term representing that constraint condition. In the process 2, similarly, the conversion section 12 generates a penalty term and converts variables x₃ and x₄ into binary variables.

The integration section 13 generates a value to be added to each coefficient included in the objective function by adding, separately for each term, a coefficient included in a penalty term representing each constraint condition.

### Example Advantage of Information Processing Apparatus 2

As such, the information processing apparatus 2 in accordance with the present example embodiment carries out a plurality of processes, which respectively correspond to a plurality of groups, in a parallel manner and converts each constraint condition into a predetermined format, even in a case where the predetermined format is an LP format or an MPS format, or is a format in which each constraint condition is expressed by a coefficient included in a penalty term representing that constraint condition. Therefore, according to the information processing apparatus 2 in accordance with the present example embodiment, it is possible to bring about an example advantage of enhancing a speed to construct a mathematical model which represents an optimization problem, even in a case where the predetermined format is an LP format or an MPS format, or is a format in which each constraint condition is expressed by a coefficient included in a penalty term representing that constraint condition.

### Example Application

The following description will discuss an example application in which the information processing apparatus 2 is used in arrangement optimization of health professionals such as nurses and doctors. Specifically, an example application in which the information processing apparatus 2 is used to decide work shifts of health professionals will be described with reference to FIG. 11. Note that this example application may be applied to the configuration of the first example embodiment.

FIG. 11 illustrates an example of a table indicating work shifts of health professionals who belong to a certain organization in this example application. Specifically, FIG. 11 illustrates an example of work shifts during a target period (here, one month in June) of all health professionals including health professionals A through C belonging to the certain organization. Generation of such work shifts can be formulated as an optimization problem. For example, generation of work shifts can be regarded as a mixed integer linear programming problem, and any exact solution method can be applied. As another example, generation of work shifts can be regarded as a large-scale discrete optimization problem, and an annealing method can be applied.

In this example application, a flow of deciding work shifts including input by health professionals will be described.

In this example application, each of the health professionals who is a subject of a work shift uses a terminal apparatus to log in to an AI system (work shift management system) implemented by the information processing apparatus 2 and to input a desired work schedule. The AI system then generates optimum work shifts (see FIG. 11) by taking into consideration, as constraint conditions, a desired work schedule or the like input by each of the health professionals (nurses or doctors).

In this configuration, first, the AI system sets, as a decision variable, a work form (e.g., necessity for work) for each health professional for each day. Next, the AI system sets an optimization problem in which affinities, human relationships, and the like among the health professionals are set as constraint conditions, in addition to the above-described desired work schedules or the like. The information processing apparatus 2 in accordance with the present example embodiment then generates work shifts based on a final output solution of the optimization problem. The AI system provides notification to each of the health professionals by displaying the generated work shifts on a terminal apparatus or the like.

Subsequently, each of the health professionals confirms the generated work shifts on a terminal apparatus or the like. In a case where it has been determined that there is no problem in the generated work shift, each of the health professionals uses the terminal apparatus to log in to the AI system and to input approval for the work shift. Meanwhile, in a case where it has been determined that there is a problem in the generated work shift, each of the health professionals uses the terminal apparatus to log in to the AI system and to input a request for correction of the work shift.

Upon detection of input of a request for correction of the work shift, the AI system corrects the optimization problem by, for example, adding a new constraint condition based on the correction request. The addition of a constraint condition or the like may be carried out based on user input by an administrator of the AI system who has confirmed the correction request. Then, the AI system obtains a final output solution of the corrected optimization problem and generates work shifts which the final output solution indicates. In a case where, in this configuration, work shifts which have been approved by all the subject health professionals have been generated, the AI system decides the work shifts as final work shifts.

Thus, by using the information processing apparatus 2 for work shift generation, it is possible to support decision making of an administrator in a medical facility.

### Software Implementation Example

Some or all of the functions of each of the information processing apparatuses 1 and 2 may be implemented by hardware such as an integrated circuit (IC chip), or may be implemented by software.

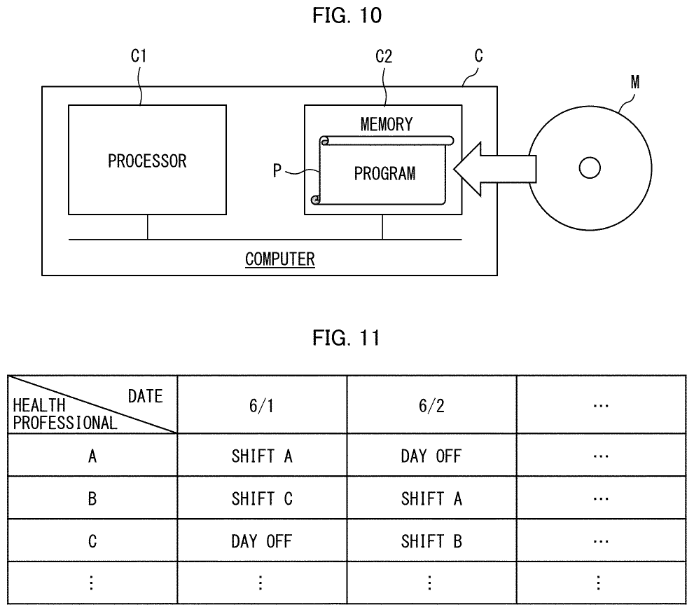

In the latter case, each of the information processing apparatuses 1 and 2 is realized by, for example, a computer that executes instructions of a program that is software realizing the foregoing functions. FIG. 10 illustrates an example of such a computer (hereinafter, referred to as “computer C”). The computer C includes at least one processor C1 and at least one memory C2. The memory C2 stores a program P for causing the computer C to function as the information processing apparatuses 1 and 2. The processor C1 of the computer C retrieves the program P from the memory C2 and executes the program P, so that the functions of the information processing apparatuses 1 and 2 are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface through which data can be transmitted to and received from another apparatus. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary Note 1

An information processing apparatus including: a division means that divides, into a plurality of groups, a plurality of constraint conditions which have been input; a conversion means that carries out a conversion process of converting each of the plurality of constraint conditions into a predetermined format; and an integration means that integrates the plurality of constraint conditions which are expressed in the predetermined format, the conversion means carrying out, in a parallel manner, a plurality of processes which respectively correspond to the plurality of groups, where each of the plurality of processes is constituted by conversion processes on respective constraint conditions belonging to one group.

### Supplementary Note 2

The information processing apparatus according to supplementary note 1, further including: a prediction means that predicts a process time that is taken for the conversion means to carry out the conversion process on each of the plurality of constraint conditions.

### Supplementary Note 3

The information processing apparatus according to supplementary note 2, in which: he division means divides, with reference to process times predicted by the prediction means, the plurality of constraint conditions into the plurality of groups so that a process time that is taken for the conversion means to carry out conversion processes on all the plurality of constraint conditions is minimized.

### Supplementary Note 4

The information processing apparatus according to supplementary note 3, in which: the prediction means predicts, with use of a prediction model generated by machine learning while using the plurality of constraint conditions as input, a process time that is taken for the conversion means to carry out the conversion process on each of the plurality of constraint conditions.

### Supplementary Note 5

The information processing apparatus according to supplementary note 3, in which: the prediction means predicts, with use of a rule-based algorithm, a process time that is taken for the conversion means to carry out the conversion process on each of the plurality of constraint conditions.

### Supplementary Note 6

The information processing apparatus according to supplementary note 1, in which: the division means divides the plurality of constraint conditions into the plurality of groups so that a difference in the number of conversion processes is minimized between the plurality of processes carried out in a parallel manner.

### Supplementary Note 7

The information processing apparatus according to any one of supplementary notes 1 through 7, in which: the plurality of constraint conditions are constraint conditions with respect to a linear programming problem, an integer linear programming problem, or a mixed integer linear programming problem; and the predetermined format is a linear programming (LP) format or a mathematical programming system (MPS) format.

### Supplementary Note 8

The information processing apparatus according to any one of supplementary notes 1 through 7, in which: the plurality of constraint conditions are constraint conditions with respect to a quadratic unconstrained binary optimization problem; and the predetermined format is a format in which each constraint condition is expressed by a coefficient included in a penalty term representing that constraint condition.

### Supplementary Note 9

An information processing method including: dividing, into a plurality of groups by an information processing apparatus, a plurality of constraint conditions which have been input; carrying out, by the information processing apparatus, a conversion process of converting each of the plurality of constraint conditions into a predetermined format; and integrating, by the information processing apparatus, the plurality of constraint conditions which are expressed in the predetermined format, in the carrying out, a plurality of processes which respectively correspond to the plurality of groups being carried out in a parallel manner by the information processing apparatus, where each of the plurality of processes is constituted by conversion processes on respective constraint conditions belonging to one group.

### Supplementary Note 9a

The information processing method according to supplementary note 9, further including: predicting a process time that is taken, in the carrying out, to carry out the conversion process on each of the plurality of constraint conditions.

### Supplementary Note 9b

The information processing method according to supplementary note 9 or 9a, in which: the plurality of constraint conditions are constraint conditions with respect to a linear programming problem, an integer linear programming problem, or a mixed integer linear programming problem; and the predetermined format is a linear programming (LP) format or a mathematical programming system (MPS) format.

### Supplementary Note 9c

The information processing method according to supplementary note 9 or 9a, in which: the plurality of constraint conditions are constraint conditions with respect to a quadratic unconstrained binary optimization problem; and the predetermined format is a format in which each constraint condition is expressed by a coefficient included in a penalty term representing that constraint condition.

### Supplementary Note 10

A program for causing a computer to function as an information processing apparatus, the program causing the computer to function as: a division means that divides, into a plurality of groups, a plurality of constraint conditions which have been input; a conversion means that carries out a conversion process of converting each of the plurality of constraint conditions into a predetermined format; and an integration means that integrates the plurality of constraint conditions which are expressed in the predetermined format, the conversion means carrying out, in a parallel manner, a plurality of processes which respectively correspond to the plurality of groups, where each of the plurality of processes is constituted by conversion processes on respective constraint conditions belonging to one group.

### Supplementary Note 10a

The program according to supplementary note 10, in which: the program causing the computer to function further as a prediction means that predicts a process time that is taken for the conversion means to carry out the conversion process on each of the plurality of constraint conditions.

### Supplementary Note 10b

The program according to supplementary note 10 or 10a, in which: the plurality of constraint conditions are constraint conditions with respect to a linear programming problem, an integer linear programming problem, or a mixed integer linear programming problem; and the predetermined format is a linear programming (LP) format or a mathematical programming system (MPS) format.

### Supplementary Note 10c

The program according to supplementary note 10 or 10a, in which: the plurality of constraint conditions are constraint conditions with respect to a quadratic unconstrained binary optimization problem; and the predetermined format is a format in which each constraint condition is expressed by a coefficient included in a penalty term representing that constraint condition.

### Supplementary Note 11

An information processing apparatus including at least one processor, the at least one processor carrying out: a division process of dividing, into a plurality of groups, a plurality of constraint conditions which have been input; a conversion process of converting each of the plurality of constraint conditions into a predetermined format; and an integration process of integrating the plurality of constraint conditions which are expressed in the predetermined format, in the conversion process, the at least one processor carrying out, in a parallel manner, a plurality of processes which respectively correspond to the plurality of groups, where each of the plurality of processes is constituted by conversion processes on respective constraint conditions belonging to one group.

Note that the information processing apparatus can further include a memory. The memory can store a program for causing the at least one processor to carry out the division process, the conversion process, and the integration process. The program can be stored in a computer-readable non-transitory tangible storage medium.

### REFERENCE SIGNS LIST

1, 2: Information processing apparatus
11: Division section
12: Conversion section
13: Integration section
14: Acquisition section
15: Prediction section
16: Output section

1. An information processing apparatus comprising at least one processor, the at least one processor carrying out:
a division process of dividing, into a plurality of groups, a plurality of constraint conditions which have been input;
a conversion process of converting each of the plurality of constraint conditions into a predetermined format; and
an integration process of integrating the plurality of constraint conditions which are expressed in the predetermined format,
in the conversion process, a plurality of processes which respectively correspond to the plurality of groups being carried out in a parallel manner by the at least one processor, where each of the plurality of processes is constituted by conversion processes on respective constraint conditions belonging to one group.

2. The information processing apparatus according to claim 1, wherein:
the at least one processor further carries out a prediction process of predicting a process time that is taken to carry out the conversion process on each of the plurality of constraint conditions in the conversion process.

3. The information processing apparatus according to claim 2, wherein:
in the division process, the at least one processor divides, with reference to process times predicted in the prediction process, the plurality of constraint conditions into the plurality of groups so that a process time that is taken to carry out conversion processes on all the plurality of constraint conditions in the conversion process is minimized.

4. The information processing apparatus according to claim 3, wherein:
in the prediction process, the at least one processor predicts, with use of a prediction model generated by machine learning while using the plurality of constraint conditions as input, a process time that is taken to carry out the conversion process on each of the plurality of constraint conditions.

5. The information processing apparatus according to claim 3, wherein:
in the prediction process, the at least one processor predicts, with use of a rule-based algorithm, a process time that is taken to carry out the conversion process on each of the plurality of constraint conditions.

6. The information processing apparatus according to claim 1, wherein:
in the division process, the at least one processor divides the plurality of constraint conditions into the plurality of groups so that a difference in the number of conversion processes is minimized between the plurality of processes carried out in a parallel manner.

7. The information processing apparatus according to claim 1, wherein:
the plurality of constraint conditions are constraint conditions with respect to a linear programming problem, an integer linear programming problem, or a mixed integer linear programming problem; and
the predetermined format is a linear programming (LP) format or a mathematical programming system (MPS) format.

8. The information processing apparatus according to claim 1, wherein:
the plurality of constraint conditions are constraint conditions with respect to a quadratic unconstrained binary optimization problem; and
the predetermined format is a format in which each constraint condition is expressed by a coefficient included in a penalty term representing that constraint condition.

9. An information processing method comprising:
dividing, into a plurality of groups by at least one processor, a plurality of constraint conditions which have been input;
carrying out, by the at least one processor, a conversion process of converting each of the plurality of constraint conditions into a predetermined format; and
integrating, by the at least one processor, the plurality of constraint conditions which are expressed in the predetermined format,
in the carrying out, a plurality of processes which respectively correspond to the plurality of groups being carried out in a parallel manner by the at least one processor, where each of the plurality of processes is constituted by conversion processes on respective constraint conditions belonging to one group.

10. A computer-readable non-transitory storage medium storing a program for causing a computer to function as an information processing apparatus, the program causing the computer to carry out:
a division process of dividing, into a plurality of groups, a plurality of constraint conditions which have been input;
a conversion process of converting each of the plurality of constraint conditions into a predetermined format; and
an integration process of integrating the plurality of constraint conditions which are expressed in the predetermined format,
in the conversion process, a plurality of processes which respectively correspond to the plurality of groups being carried out in a parallel manner by the computer, where each of the plurality of processes is constituted by conversion processes on respective constraint conditions belonging to one group.
